(19) United States
(12) Patent Application Publication
(10) Pub. No.: US 2025/0159569 A1
(43) Pub. Date: May 15, 2025

(54) Systems and Methods for User Equipment History Information Update for Conditional Handover and Conditional Primary Secondary Cell Group Cell Change

(71) Applicant: Telefonaktiebolaget LM Ericsson (publ), Stockholm (SE)

(72) Inventors: Pradeepa Ramachandra, Linköping (SE); Marco Belleschi, Solna (SE); Julien Muller, Rennes (FR)

(21) Appl. No.: 18/726,892

(22) PCT Filed: Dec. 30, 2022
(86) PCT No.: PCT/SE2022/051260

§ 371 Date: Jul. 5, 2024

Related U.S. Application Data
(60) Provisional application No. 63/296,932, filed on Jan. 6, 2022.

(51) Int. Cl. H04W 36/00; H04W 36/36

(52) U.S. Cl. CPC H04W 36/008375; H04W 36/362

(57) ABSTRACT

A method (400) by a target network node (510B) associated with a Conditional Handover, CHO, or Conditional Primary Secondary Cell Group Cell, PSCell, change of a user equipment, UE (512) is provided. The method includes receiving (401), from a source network node (510A), a first message requesting the CHO or Conditional PSCell change of the UE. The first message includes user equipment history information, UHI. The target network node receives (402), from the UE, a second message indicating a completion of applying a RRC reconfiguration. The target network node updates (403) the UHI based on an amount of time between receiving the first message comprising the UHI and receiving the second message indicating the completion of applying the RRC reconfiguration.

### TECHNICAL FIELD

The present disclosure relates, in general, to wireless communications and, more particularly, systems and methods for User Equipment History Information (UHI) update for Conditional Handover (CHO) and Conditional Primary Secondary Cell Group Cell (PSCell) Change.

### BACKGROUND

UHI was introduced in Long Term Evolution (LTE) and has been adopted in New Radio (NR). The source Radio Access Network (RAN) node collects and stores UHI for the duration when a User Equipment (UE) is connected and stays in one of its cells.

The UHI collected by the RAN node varies depending upon whether it is NR or LTE, but they have similarities. The UHI includes cell identifier of the serving Primary Cell (PCell), the time UE stayed in the cell and the Handover (HO) cause. The maximum number of cells in UHI is capped at 16 entries.

The procedural text related to accumulation of UHI by the concerned Next Generation-Radio Access Network (NG-RAN) node is found in Section 15.5.4 of 3GPP TS 38.300, and the corresponding ASN.1 can be found in IE UE History Information in Section 9.3.1.95 of 3GPP TS 38.413.

The procedural text related to accumulation of UHI by the concerned eNB node is found in Section 16.2.2.1 of 3GPP TS 36.300, and the corresponding ASN.1 can be found in IE UE History Information in section 9.2.1.42 of 3GPP TS 36.413.

It is important to note that UHI differs from Mobility History Information (MHI), which is collected by the UE and then transferred to the network. Rather, UHI is collected by the concerned network nodes.

### Conditional Handover (CHO)

Handovers are normally triggered when the UE is at the cell edge and experiences poor radio conditions. If the UE enters poor radio conditions quickly, the conditions may already be so poor that the actual handover procedure may be hard to execute. If the uplink (UL) is already bad, it may lead to the network not being able to detect the measurement report transmitted by the UE. Thus, the network node may not be able to initiate the handover procedure. Downlink (DL) problems may lead to the handover command (i.e. the RRCReconfiguration message with a reconfigurationWithSync field) not successfully reaching the UE. In poor radio conditions, the DL message is often segmented, which increases the risk of retransmissions with an increased risk that the message doesn't reach the UE in time. Failed transmission of the handover command is a common reason for unsuccessful handovers.

To improve mobility robustness and address the issues above, a concept known as CHO was introduced in 3GPP Release 16. The key idea in CHO is that transmission and execution of the handover command are separated. This allows the handover command to be sent earlier to UE when the radio conditions are still good and increases the likelihood that the handover command is successfully transferred. The execution of the handover command is done at later point in time based on an associated execution condition. The execution condition is typically in the form a threshold. For example, the condition may be fulfilled if the signal strength of a candidate target cell becomes X dB better than the serving cell. This is called an A3 event. As another example, the condition may be fulfilled if the signal strength of the serving cell becomes worse than X dBm and signal strength of candidate target cell becomes better than Y dBm. This is called an A5 event.

As used herein, a cell for which CHO (or other conditional mobility procedure) is configured is denoted “candidate target cell” or “potential target cell”. Similarly, a radio network node controlling a candidate/potential target cell is denoted “candidate target node” or “potential target node”. In a sense, once the CHO execution condition has been fulfilled for a candidate/potential target cell and CHO execution towards this candidate/potential target cell has been triggered, this cell is no longer considered a “potential” or “candidate” cell since it is no longer uncertain whether the CHO will be executed towards the cell. As such, after the CHO execution condition has been fulfilled/triggered, the concerned candidate or potential target cell is herein sometimes referred to simply as “target cell”.

FIG. 1 illustrates the signaling flow for a CHO in NR. As depicted, the signaling for CHO in NR includes:

1-2: The UE and source gNodeB (gNB) have an established connection and is exchanging user data. Due to some trigger, e.g. a measurement report from the UE, the source gNB decides to configure one or multiple CHO candidate cells. The threshold used for the measurement reporting should be chosen lower than the one in the handover execution condition. This allows the serving cell to prepare the handover when the radio link to the UE is still stable. The execution of the handover is done at a later point in time (and threshold) which is considered optimal for the handover execution.

3-4: Same as in the legacy handover procedure except that the source node indicates that the handover is a CHO.

5-6: To configure a candidate target cell the source node sends the CHO configuration (i.e. a RRCReconfiguration message) to the UE which contains the handover command and the associated execution condition.

The handover command (also an RRCReconfiguration message) is generated by the target node during the Handover Preparation phase and the execution condition is generated by the source node.

7-8: Later on, if the execution condition is met, the UE executes the handover by performing random access and sending the handover complete message (i.e. an RRCReconfigurationComplete message) to the target node.

9: The target gNB sends a HANDOVER SUCCESS message to the source gNB indicating the UE has successfully established the target connection.

10-11: Upon reception of the handover success indication, the source gNB stops scheduling any further DL or UL data to the UE and sends a SN STATUS TRANSFER message to the target gNB indicating the latest PDCP SN transmitter and receiver status. The source node now also starts to forward User Data to the target node.

12: Same as in the legacy handover procedure

### Successful Handover Report (SHR)

SHR has been discussed in Release 16 and is under standardization in Release 17. The following outcome was captured at the end of System Information (SI) in 3GPP TS 37.816 v16.0.0.

The Mobility Robustness Optimization (MRO) function in NR could be enhanced to provide a more robust mobility via reporting failure events observed during successful handovers. A solution to this problem is to configure the UE to compile a report associated to a successful handover comprising a set of measurements collected during the handover phase, i.e. measurement at the handover trigger, measurement at the end of handover execution or measurement after handover execution. The UE could be configured with triggering conditions to compile the SHR such that the report is triggered only if the conditions are met. This limits UE reporting to relevant cases, such as underlying issues detected by Radio Link Monitoring (RLM), or Beam Failure Detection (BFD) detected upon a successful handover event.

The availability of a SHR may be indicated by the Handover Complete message (i.e., RRCReconfigurationComplete message) transmitted from UE to target NG-RAN node over Radio Resource Control (RRC). The target Next Generation-Radio Access Network (NG-RAN) node may fetch information of a SHR via UE Information Request/Response mechanism. In addition, the target NG-RAN node could then forward the SHR to the source NR-RAN node to indicate failures experienced during a successful handover event.

The information contained in the SHR may include:
RLM related information,
RLM related timer(s) information (e.g., T310, T312),
measurements of reference signals used for RLM in terms of Reference Signal Received Power (RSRP), Reference Signal Received Quality (RSRQ), Signal to Interference and Noise Ratio (SINR), etc.,
RLC retransmission counter,
BFD related information,
detection indicators and counters (e.g., Qin and Qout indications),
measurements of reference signals used in BFD in terms of RSRP, RSRQ, SINR, etc.,
handover related information,
measurements of the configured reference signals at the time of successful handover,
Synchronization Signal Block (SSB) beam measurements,
Channel State Information-Reference Signal (CSI-RS) measurements,
handover related timer(s) information (e.g., T304), and/or
measurement period indication (i.e., measurements are collected at handover trigger, at the end of handover execution or just after handover execution).

Upon reception of a SHR, the receiving node is able to analyse whether its mobility configuration needs adjustment. Such adjustments may result in changes of mobility configurations, such as changes of RLM configurations or changes of mobility thresholds between the source and the target. In addition, target NG RAN node, in the performed handover, may further optimize the dedicated RACH-beam resources based on the beam measurements reported upon successful handovers.

There currently exist certain challenge(s). For example, the UHI is sent from a source network node to a target network node during the Handover Preparation procedure. The UHI contains, among other parameters, the time the UE has spent in the last serving cell, which may be referred to as the source cell. However, for CHO, the time between the Handover Preparation procedure and the actual Handover Execution (when the CHO condition is fulfilled) is not negligeable. Since the handover will be executed by the UE when certain radio channel conditions are fulfilled, the UE will stay in the source cell after Handover Preparation procedure, for a non-negligeable and potentially unpredictable amount of time. In that case, the Time UE Stayed in Cell parameters related to the last UHI PCell and PSCell entries (i.e. from the source Master Node (MN) and source Secondary Node (SN)) is not accurate in the UHI received by the target node. The time between the Handover Preparation and the actual Handover Execution will not be counted and may lead to inexactitudes in Self-Organizing Network (SON) mobility algorithms.

### SUMMARY

Certain aspects of the disclosure and their embodiments may provide solutions to these or other challenges. For example, methods and systems are provided that include a new timer for calculating the time between Conditional Handover Preparation and Conditional Handover Execution. As another example, methods and systems are provided that include a new message transmitted from the source node to the target node to update UHI in target node after completing the conditional HO. The target node may update the UHI based on the timer used to calculate the 20 time between Conditional Handover Preparation and CHO Execution and/or the message received from the source node.

According to certain embodiments, a method by a target network node associated with a CHO or Conditional PSCell change of a UE includes receiving, from a source network node, a first message requesting the CHO or Conditional PSCell change of the UE. The first message includes UHI. The target network node receives, from the UE, a second message indicating a completion of applying a RRC reconfiguration. The target network node updates the UHI based on an amount of time between receiving the first message comprising the UHI and receiving the second message indicating the completion of applying the RRC reconfiguration.

According to certain embodiments, a target network node associated with a CHO or Conditional PSCell change of a UE includes processing circuitry configured to receive, from a source network node, a first message requesting the CHO or Conditional PSCell change of the UE. The first message includes UHI. The processing circuitry is configured to receive, from the UE, a second message indicating a completion of applying a RRC reconfiguration. The processing circuitry is configured to update the UHI based on an amount of time between receiving the first message comprising the UHI and receiving the second message indicating the completion of the applying the RRC reconfiguration.

Certain embodiments may provide one or more of the following technical advantage(s). For example, certain embodiments may provide a technical advantage of allowing the target node to update the latest PCell and PSCell entries of the UHI with the real Time UE Stayed in Cell parameter in case of CHO.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the signaling flow for a CHO in NR;

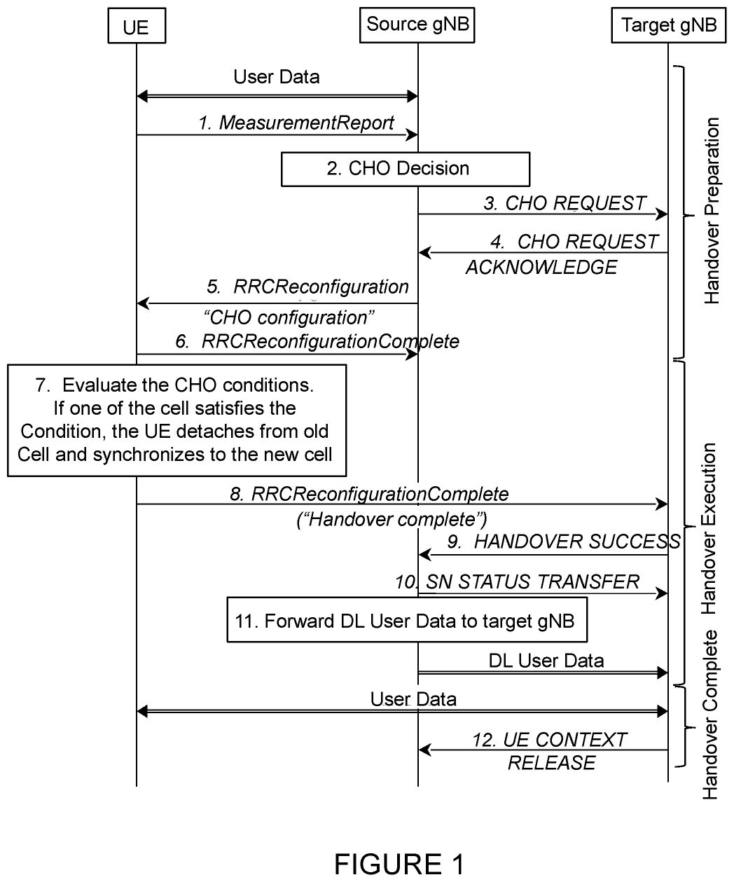

FIG. 2 illustrates an example method by a source network node to update the last PCell and/or PSCell entries of the UHI associated to a UE, according to certain embodiments;

FIG. 3 illustrates an example method by a target network node to update the last PCell and/or PSCell entries of the UHI associated to a UE, according to certain embodiments;

FIG. 4 illustrates an example method by a target network node for counting time between Handover Preparation and Successful Access, according to certain embodiments;

FIG. 5 illustrates an example method by a target network node associated with a CHO or Conditional PSCell change of a UE, according to certain embodiments;

FIG. 6 illustrates an example communication system, according to certain embodiments;

FIG. 7 illustrates an example UE, according to certain embodiments;

FIG. 8 illustrates an example network node, according to certain embodiments;

FIG. 9 illustrates a block diagram of a host, according to certain embodiments;

FIG. 10 illustrates a virtualization environment in which functions implemented by some embodiments may be virtualized, according to certain embodiments; and

FIG. 11 illustrates a host communicating via a network node with a UE over a partially wireless connection, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

For the proposed solution, some general disclaimers and considerations apply. For example, the terms ‘source node’ and ‘source network node’ are used interchangeably herein to refer to a node from which a UE is handed over during a CHO, for example. It is recognized that a source node can be a source gNB, a source Enhanced-gNB (en-gNB), a source eNB, a source Next Generation-eNB (ng-eNB), a source gNB-Centralized Unit (gNB-CU), a source gNB-Centralized Unit-Control Plane (gNB-CU-CP), a source Enhanced-gNB-Centralized Unit (en-gNB-CU), a source Enhanced-gNB-Centralized Unit-Control Plane (en-gNB-CU-CP), a source eNB-Control Plane (eNB-CP), a source Next Generation-eNB-Centralized Unit (ng-eNB-CU), and a source Next Generation-eNB-Centralized Unit-Control Plane (ng-eNB-CU-CP), in various particular embodiments.

As another example, the terms ‘target node’ and ‘target network node’ are used interchangeably herein to refer to a node to which a UE is handed over during a CHO, for example. It is recognized that a target node (from an handover point-of-view) can be a target gNB, a target en-gNB, a target eNB, a target ng-eNB, a target gNB-CU, a target gNB-CU-CP, a target en-gNB-CU, a target en-gNB-CU-CP, a target eNB-CP, a target ng-eNB-CU, a target ng-eNB-CU-CP, in various particular embodiments.

The same applies to source cell and target cell belonging to a source node or a target node, respectively.

The term CHO is used herein. However, any solutions, methods, and techniques described herein are equally applicable to conditional PSCell change. Thus, the term CHO is used very generally herein to refer to both CHO and conditional PSCell change.

According to certain embodiments, methods and systems are provided that include a new message that is transmitted from the source node to the target node to update UHI in target node after completing the CHO. Additionally or alternatively, certain methods and systems include a new timer for calculating the time between the Handover Preparation and CHO Execution. The target node may update the UHI based on the timer used to calculate the time between the Handover Preparation and CHO Execution and/or the message received from the source node.

### Source Node Sends Information to Update UHI to the Target RAN Node

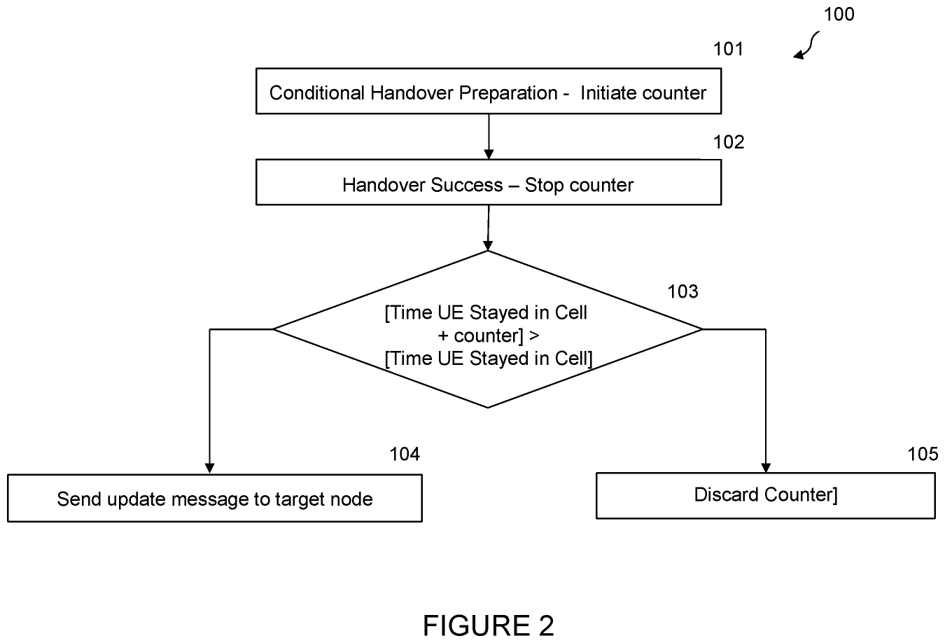

FIG. 2 illustrates an example method 100 by a source network node to update the last PCell and/or PSCell entries of the UHI associated to a UE, according to certain embodiments. The last PCell and/or PSCell entries of the UHI associated to a UE was sent to the target network node at Handover Preparation during a CHO. The method is performed after successful execution of the CHO to the target network node such as, for example, upon reception of the Handover Success message from the target network node.

In particular, as illustrated in FIG. 2, the method by the source network node includes initiating, at step 201, a counter (in seconds or milliseconds) at Conditional Handover Preparation. For example, the source network node may initiate the counter when sending the HANDOVER REQUEST message with the CHO flag to the candidate target network node), in a particular embodiment. As used herein, the term ‘Conditional Handover Preparation’ refers to the HANDOVER REQUEST message that, for the case of CHO, carries the field ‘conditional handover Information request,’ as disclosed in 3GPP TS 38.423.

At step 102, the source network node, stops the counter when the source network node receives the information that the UE successfully accessed one of the candidate target cells belonging to a candidate target node (i.e., at reception of the HANDOVER SUCCESS message from the target network node).

At step 103, the source network node evaluates whether the Time UE Stayed in Cell parameters for the latest PCell and PSCell entries of the UHI need to be updated in the target network node. For example, the UHI needs to be updated if [Time UE Stayed in Cell+counter] is different from the Time UE Stayed in Cell parameter sent to the target network node during the Conditional Handover Preparation.

At step 104, when the source network node determines that the parameters need to be updated, the source network node sends a message to the target network node containing one of the following information:
a. the time between Conditional Handover Preparation and the reception of the Handover Success message,
b. an updated UHI with an updated value of the Time UE Stayed in Cell parameter for the latest PCell and PSCell entries, wherein this updated value is the sum of the Time UE Stayed in Cell (indicated in the previous UHI) and represents the time between when the UE connected to the source cell to the time of sending the handover preparation to the target network node, and the time between Conditional Handover Preparation and the reception of the Handover Success message.
   Alternatively, at step 105, when the source network node determines that the parameters do not need to be updated, the source network node discards the counter created at step 101.

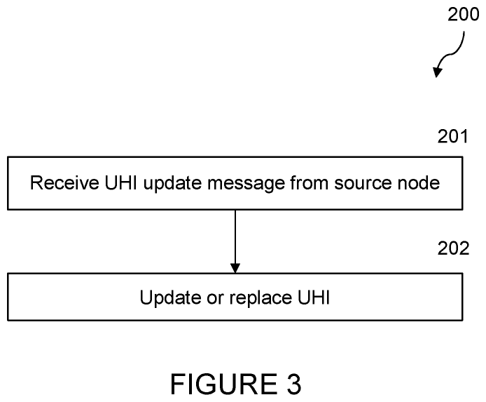

FIG. 3 illustrates an example method 200 by a target network node to update the last PCell and/or PSCell entries of the UHI associated to a UE, according to certain embodiments. In a particular embodiment, the last PCell and/or PSCell entries were received from a source network node at Handover Preparation during a CHO.

As depicted in FIG. 3, the method includes receiving, at step 201, a message from the source network node that including one of the following information:
a. the time between Conditional Handover Preparation and the reception of the Handover Success message, and/or
b. an updated UHI with an updated value of the Time UE Stayed in Cell parameter for the latest PCell and PSCell entries, wherein this updated value is the sum of the Time UE Stayed in Cell (indicated in the previous UHI) and represents the time between when the UE connected to the source cell to the time of sending the handover preparation to the target network node, and the time between Conditional Handover Preparation and the reception of the Handover Success message.

At step 202, the target network node updates the UHI based on the message received at step 201. For example, the target network node may update the UHI received during the Conditional Handover Preparation phase with the new Time UE Stayed in Cell values (i.e. old Time UE Stayed in Cell+counter). Alternatively, the target network node may replace the parameters with the new UHI received in the update message.

An example of the new message implementation is represented in this proposed modification to 3GPP TS 38.423:
9.1.1.x UE History Information update
This message is sent by the source NG-RAN node to the target NG-RAN node to signal an updated UHI.
Direction: source NG-RAN node→target NG-RAN node.

| | | | | |
|---|---|---|---|---|
| IE/Group | | | IE type and | Semantics |
| Name | Presence | Range | reference | description |

| | | | |
|---|---|---|---|
| Message Type | M | 9.2.3.1 | |
| Source NG-RAN | M | NG-RAN | Allocated at the |
| node UE | | node UE | source |
| XnAP ID | | XnAP ID | NG-RAN node. |
| | | 9.2.3.16 | |
| Target NG-RAN | M | NG-RAN | Allocated at the |
| node UE | | node UE | target NG-RAN |
| XnAP ID | | XnAP ID | node. |
| | | 9.2.3.16 | |
| Updated UE | M | UE History | Updated UE |
| History | | Information | History |
| Information | | 9.2.3.64 | Information for |
| | | | the UE |

According to certain methods described above, the source network node of the CHO updates the target node of the CHO with the updated UHI after identifying that the UE has completed the HO towards the target network node.

In a particular embodiment, the updated UHI information is the delta time difference between the time of transmitting the latest handover preparation information for the UE to the target network node and the time of receiving an indication from the target network node that the UE has arrived at the target network node.

In some other particular embodiments, the updated UHI information is the sum of the time of stay for the latest PCell and/or PSCell in the latest handover preparation information message sent to the target network node for this UE and the time difference between the time of transmitting the latest handover preparation information to the target network node for this UE and the time of receiving an indication from the target network node that this UE has arrived at the target network node. The advantage of this particular embodiment is that the source network node need not start a new timer after every Conditional Handover preparation message transmission to a target network node. Instead, the source network node continues to run the timer associated to the timeOfStay in the UHI for the PCell and/or PSCell and stops it only after receiving an indication from the target network node that the UE has arrived at the target network node.

### Candidate Target Node Counts Time Between Handover Preparation and Successful Access

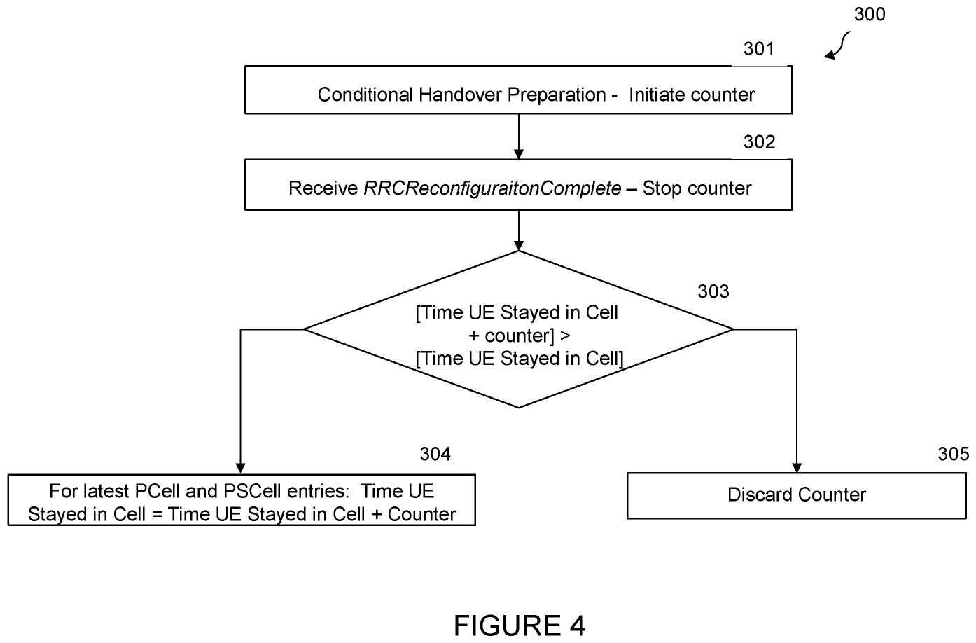

According to certain other embodiments, the candidate target network node counts the time between when Handover Preparation occurs and when successful access to the target cell is determined. For example, FIG. 4 illustrates an example method 300 by a target network node for counting time between Handover Preparation and Successful Access, according to certain embodiments.

As depicted, the method includes, at step 301, initiating a counter (in seconds or milliseconds) at Conditional Handover Preparation such as, for example, when the target network node receives the HANDOVER REQUEST message with the CHO flag from the source network node. At step 302, the target network node stops the counter when the UE successfully accessed one of the cells of the target network node. For example, the target network node may stop the counter at reception of the RRCReconfigurationComplete message, in a particular embodiment. At step 303, the target network node evaluates whether the Time UE Stayed in Cell parameters for the latest PCell and PSCell entries of the UHI have to be updated. For example, the target network node may determine that the latest PCell and PSCell entries of the UHI need to be updated if[Time UE Stayed in Cell+counter] is different from the Time UE Stayed in Cell parameter as received from the source network node during the Conditional Handover Preparation.

At step 304, if the target network node determines that the parameters need to be updated, the target network node updates the latest PCell and PSCell entries of the UHI, For example, in a particular embodiment, the target network node may update the Time UE Stayed in Cell with a new value representing the Time UE Stayed in Cell+counter. Conversely, at step 305, if the target network node determines that the parameters do not need to be updated, the target network node discards the counter created at step 301.

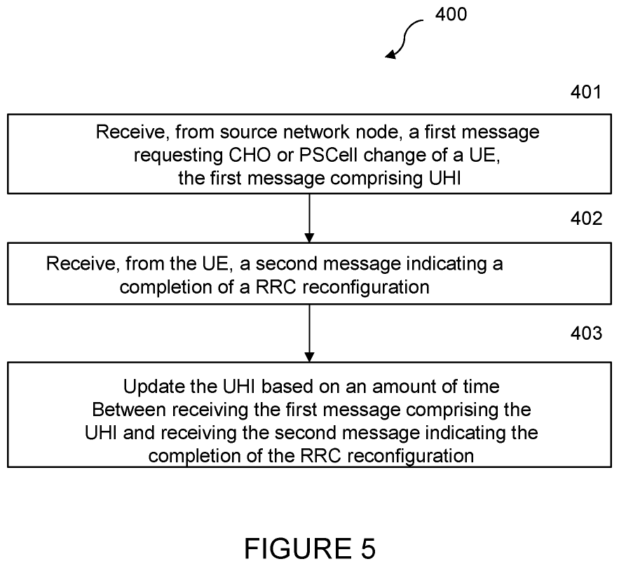

As another example, FIG. 5 illustrates an example method 400 by a target network node associated with a CHO or Conditional PSCell change of a UE, according to certain embodiments. As depicted, the method 400 includes receiving, at step 401, from a source network node, a first message requesting the CHO or Conditional PSCell change of the UE. The first message includes UHI. At step 402, the target network node receives, from the UE, a second message indicating a completion of applying a RRC reconfiguration. At step 403, the target network node updates the UHI based on an amount of time between receiving the first message comprising the UHI and receiving the second message indicating the completion of applying the RRC reconfiguration.

In a particular embodiment, the UHI includes a parameter indicating an amount of time that the UE stayed in a cell associated with the source network node before the source network node sent the first message to the target network node.

In a particular embodiment, the cell associated with the source network node comprises a Primary Cell, PCell, or a PSCell.

In a particular embodiment, the target network node transmits a third message to a candidate target network node during a handover of the UE from the target network node to the candidate target network node. The updated UHI associated with the source network node indicates an updated amount of time that the UE stayed in the cell associated with the source network node and an amount of time that the UE stayed in a cell associated with the target network node.

In a particular embodiment, the target network node updates the UHI by updating a PCell entry or PSCell entry that is associated with a cell of the source network node.

In a particular embodiment, the first message is a handover request message.

In a particular embodiment, the second message comprises a RRCReconfiguration message.

In a particular embodiment, the target network node starts a timer in response to receiving the first message and stops the timer in response to receiving the second message.

In a particular embodiment, when updating the UHI based on the amount of time between receiving the first message and receiving the second message, the target network node updates the UHI based on an amount of time associated with the timer.

In a particular embodiment, the UHI includes a plurality of parameters, and each parameter associated with an amount of time the UE stayed in a respective one of a plurality of cells.

In a particular embodiment, the target network node transmits, to the source network node, information indicating a successful completion of the CHO or the conditional PSCell change from the source to the target network node. The information indicates that the UE successfully accessed a target cell associated with the target network node.

### Target Network Node Updates the “Time UE Stayed in Cell” in the UHI on the Basis of the Information Received in the SHR

According to certain embodiments, the target network node does not leverage on any further update received from the source network node after the HO preparation. Specifically, for example, the source network node may only send the Time UE Stayed in Cell during the HO preparation. Thus, the source network node may not send any update after the HO completion, unlike the methods described above. This method can be adopted, for example, when the source network node does not support the feature of sending the update to the UHI after the HO preparation.

In a particular embodiment, the target node may instead request the SHR from the UE upon HO completion. For example, the target network node may wait for the source network node to send an update to the UHI after the HO completion. If no update is provided by the source network node within a certain time, the target network node may request the SHR directly from the UE. Alternatively, the target network node may request the source network node to provide an update to the UHI if the Conditional Handover Preparation was performed for the concerned UE. If no update to the UHI is received upon after such a request, the target network node may request the SHR from the UE.

In a particular embodiment, the SHR includes the timeSinceCHOReconfig parameter, which was started by the UE at CHO configuration in the source cell and stopped by the UE at CHO execution to the target network node. Upon fetching the timeSinceCHOReconfig in the SHR, the target network node may use it to update the UHI. For example, it may override the Time UE Stayed in Cell (received as part of the HO preparation) with the timeSinceCHOReconfig. As another example, the target network node may evaluate the difference between the timeSinceCHOReconfig and the Time UE Stayed in Cell received as part of the HO preparation and update the UHI based on the difference.

In a particular embodiment, the UE generates an SHR if the timeSinceCHOReconfig is larger than a certain threshold. For example, the network (source network node or target network node) may configure the UE while connected to the source cell with a threshold associated with the timeSinceCHOReconfig. 1f the elapsed timeSinceCHOReconfig is larger than the said configured threshold, the UE generates an SHR and stores it in the UE memory until the UE transmits the SHR upon network request.

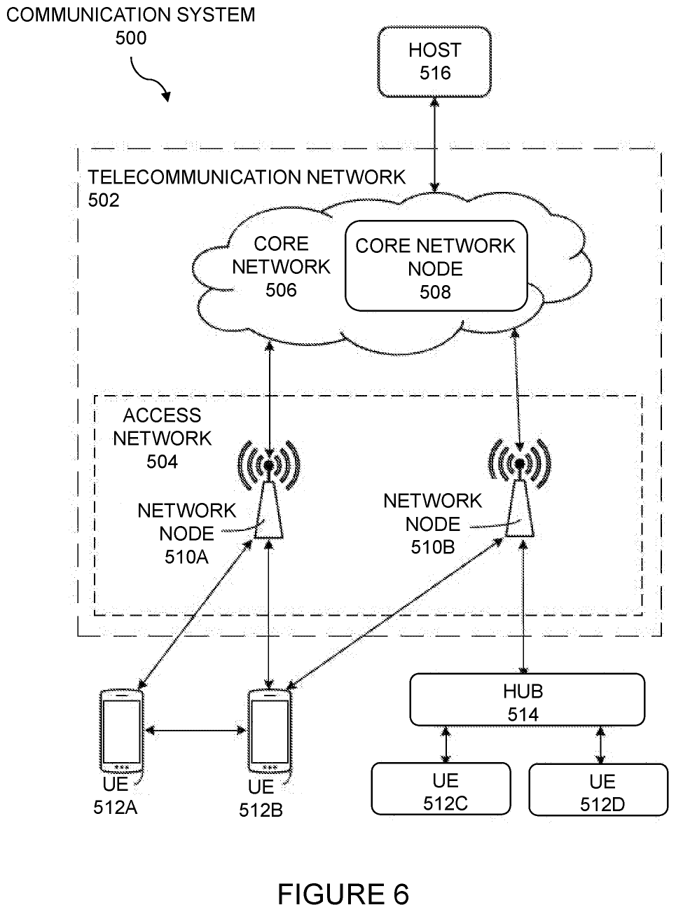

FIG. 6 shows an example of a communication system 500 in accordance with some embodiments. In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3rd Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

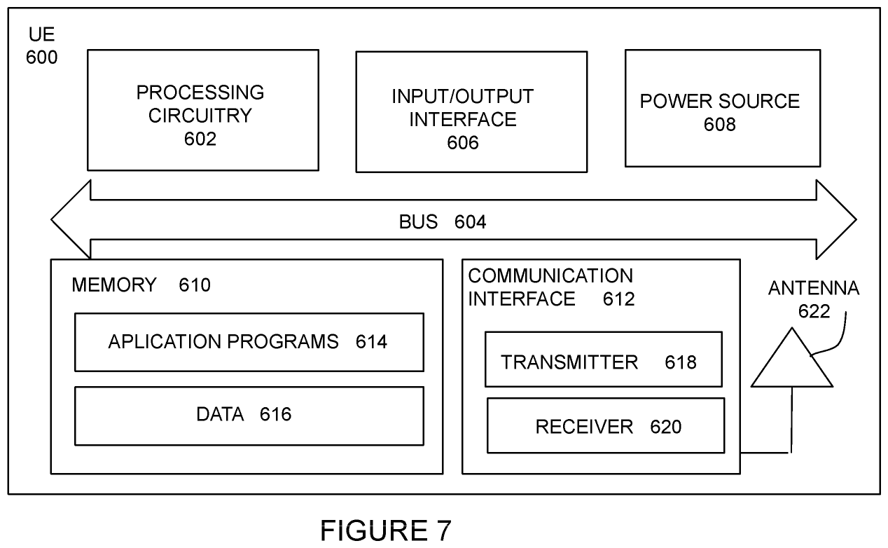

FIG. 7 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

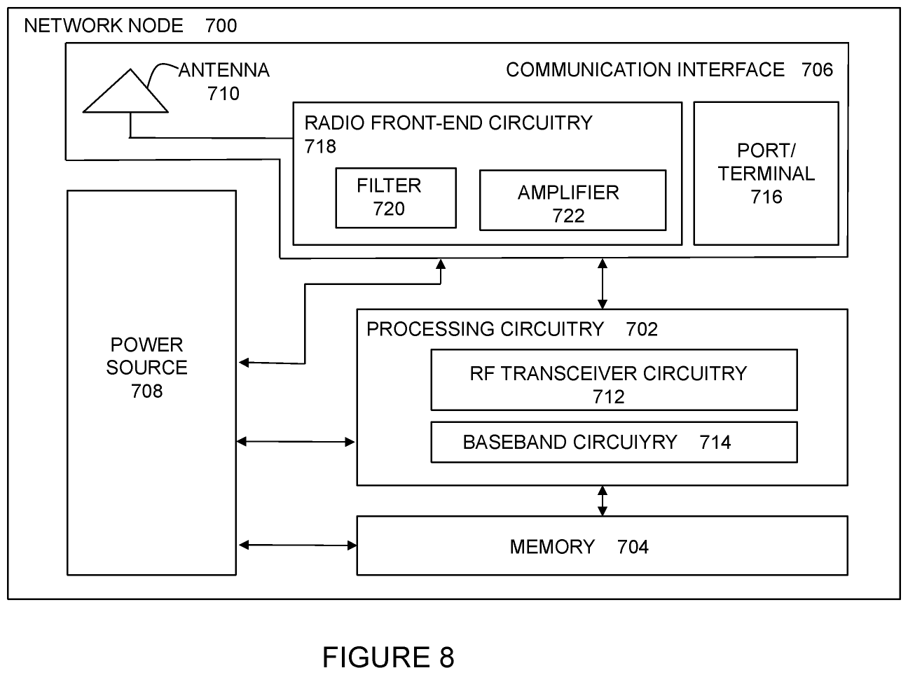

FIG. 8 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 8 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

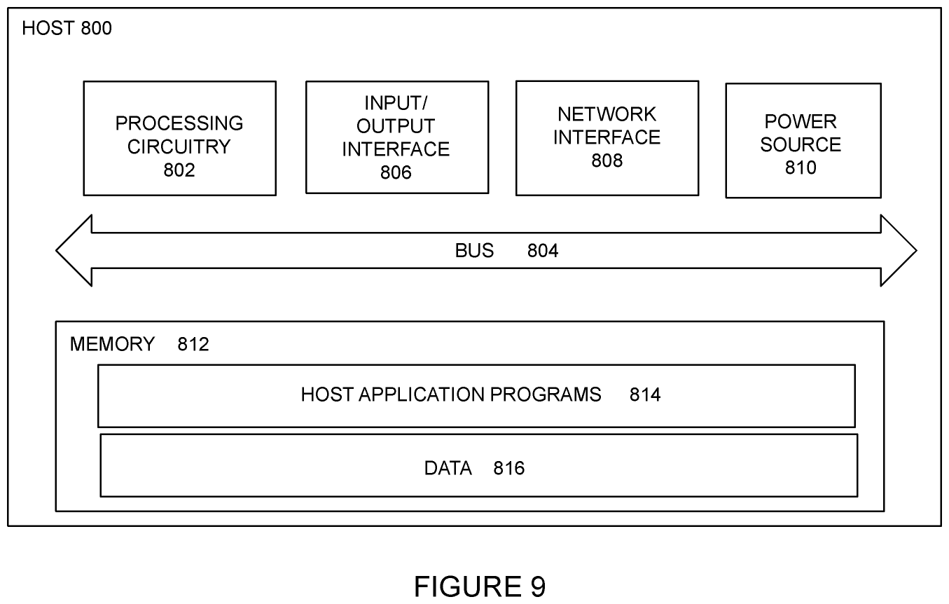

FIG. 9 is a block diagram of a host 800, which may be an embodiment of the host 516 of FIG. 6, in accordance with various aspects described herein.

As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

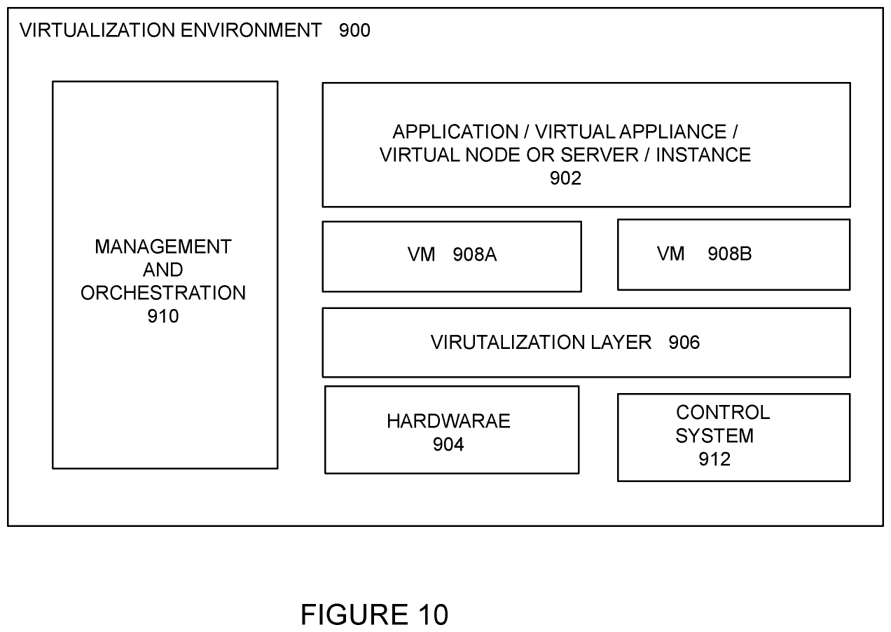

FIG. 10 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

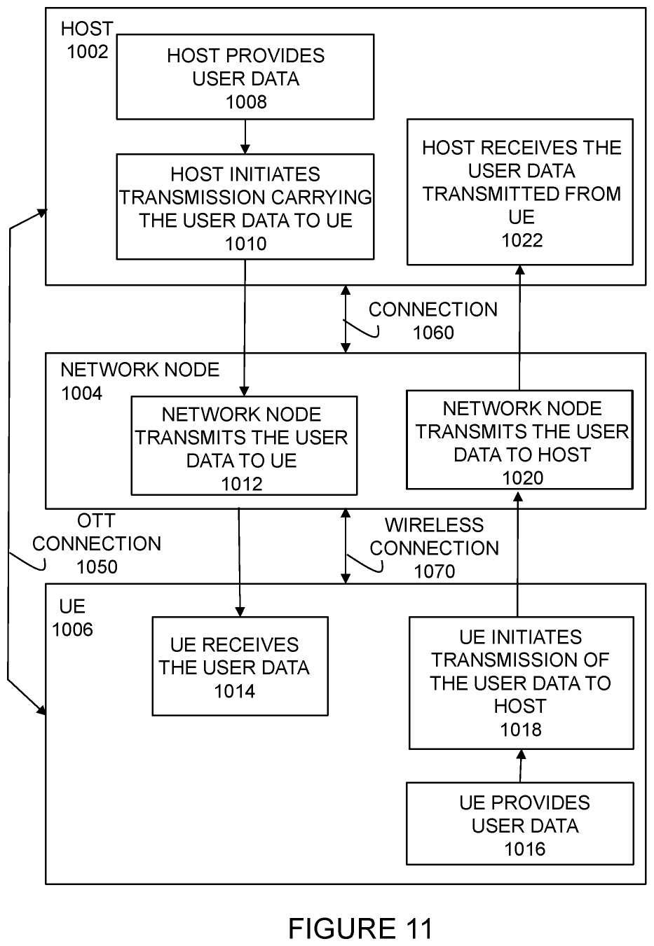

FIG. 11 shows a communication diagram of a host 1002 communicating via a network node 1004 with a UE 1006 over a partially wireless connection in accordance with some embodiments.

Example implementations, in accordance with various embodiments, of the UE (such as a UE 512a of FIG. 6 and/or UE 600 of FIG. 7), network node (such as network node 510a of FIG. 6 and/or network node 700 of FIG. 8), and host (such as host 516 of FIG. 6 and/or host 800 of FIG. 9) discussed in the preceding paragraphs will now be described with reference to FIG. 11.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 6) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a source network node, the method comprising: transmitting, to a target network node, a message comprising at least one of: an amount of time between when a conditional handover (CHO) or conditional Primary Secondary Cell (PSCell) change is initiated for a user equipment and when information indicating a successful completion of the CHO or the conditional PSCell change is received; and user equipment history information (UHI).

Example Embodiment C2. The method of Example Embodiment C1, wherein the UHI comprises a parameter associated with (and/or indicating) an amount of time the user equipment stayed in a cell.

Example Embodiment C3. The method of Example Embodiment C2, wherein the parameter comprises a Time UE Stayed in Cell parameter for at least one of a Primary Cell (PCell) and a PSCell.

Example Embodiment C4. The method of any one of Example Embodiments C1 to C3, wherein the UHI comprises an updated UHI for a latest and/or current PCell and/or PSCell.

Example Embodiment C5. The method of Example Embodiment C4, wherein the update UHI is a sum of a Time UE Stayed in Cell indicated in a previous UHI and a time between when the CHO or the conditional PSCell change is initiated and when the information indicating the successful completion of the CHO or the conditional PSCell change is received.

Example Embodiment C6. The method of any one of Example Embodiments C1 to C5, further comprising: initiating or starting a counter or timer when the CHO or conditional PSCell change is initiated; and in response to receiving the information, stopping the counter or timer.

Example Embodiment C7. The method of Example Embodiment C6, wherein the counter or timer is initiated or started when a handover request message is sent to the target network node.

Example Embodiment C8. The method of any one of Example Embodiments C6 to C7, further comprising receiving the information indicating the successful completion of the CHO or the conditional PSCell change from the target network node, the information indicating that the user equipment successfully accessed a target cell associated with the target network node.

Example Embodiment C9. The method of any one of Example Embodiments C1 to C8, further comprising determining the amount of time between when the CHO or conditional PSCell change is initiated for the user equipment and when information indicating the successful completion of the CHO or the conditional PSCell change is received.

Example Embodiment C10. The method of any one of Example Embodiments C1 to C9, wherein the network node comprises a gNodeB (gNB).

Example Embodiment C11. The method of Example Embodiments C1 to C9, further comprising: providing user data; and forwarding the user data to a host via the transmission to the network node.

Example Embodiment C12.A source network node comprising processing circuitry configured to perform any of the methods of Example Embodiments C1 to C9.

Example Embodiment C13. A computer program comprising instructions which when executed on a computer perform any of the methods of Example Embodiments C1 to C9.

Example Embodiment C14. A computer program product comprising computer program, the computer program comprising instructions which when executed on a computer perform any of the methods of Example Embodiments C1 to C9.

Example Embodiment C15.A non-transitory computer readable medium storing instructions which when executed by a computer perform any of the methods of Example Embodiments C1 to C9.

### Group D Example Embodiments

Example Embodiment D1. A method by a target network node, the method comprising: receiving, from a source network node, a message comprising at least one of: an amount of time between when a conditional handover (CHO) or conditional Primary Secondary Cell (PSCell) change is initiated for a user equipment and when information indicating a successful completion of the CHO or the conditional PSCell change is received by the source network node; and user equipment history information (UHI).

Example Embodiment D2. The method of Example Embodiment D1, wherein the UHI comprises a parameter associated with (and/or indicating) an amount of time the user equipment stayed in a cell.

Example Embodiment D3. The method of Example Embodiment D2, wherein the parameter comprises a Time UE Stayed in Cell parameter for at least one of a Primary Cell (PCell) and a PSCell.

Example Embodiment D4. The method of any one of Example Embodiments D1 to D3, wherein the UHI comprises an updated UHI for a latest and/or current PCell and/or PSCell.

Example Embodiment D5. The method of Example Embodiment D4, wherein the update UHI is a sum of a Time UE Stayed in Cell indicated in a previous UHI and a time between when the CHO or the conditional PSCell change is initiated and when the information indicating the successful completion of the CHO or the conditional PSCell change is received.

Example Embodiment D6. The method of any one of Example Embodiments D1 to D5, further comprising at least one of: updating UHI received during a Conditional Handover Preparation phase with the amount of time between when the CHO or conditional PSCell change is initiated for the user equipment and when information indicating the successful completion of the CHO or the conditional PSCell change is received by the source network node; and/or updating UHI stored at the target network node.

Example Embodiment D7. The method of Example Embodiment D6, wherein the counter or timer is initiated or started when a handover request message is sent to the target network node.

Example Embodiment D8. The method of any one of Example Embodiments D1 to D7, further comprising transmitting the information indicating the successful completion of the CHO or the conditional PSCell change from the target to the source network node, the information indicating that the user equipment successfully accessed a target cell associated with the target network node.

Example Embodiment D9. The method of any one of Example Embodiments D1 to D8, wherein the network node comprises a gNodeB (gNB).

Example Embodiment D10. The method of any of the previous Example Embodiments, further comprising: obtaining user data; and forwarding the user data to a host or a user equipment.

Example Embodiment D11. A network node comprising processing circuitry configured to perform any of the methods of Example Embodiments D1 to D10.

Example Embodiment D12. A computer program comprising instructions which when executed on a computer perform any of the methods of Example Embodiments D1 to D10.

Example Embodiment D13. A computer program product comprising computer program, the computer program comprising instructions which when executed on a computer perform any of the methods of Example Embodiments D1 to D10.

Example Embodiment D14. A non-transitory computer readable medium storing instructions which when executed by a computer perform any of the methods of Example Embodiments D1 to D10.

### Group E Example Embodiments

Example Embodiment E1. A method by a target network node, the method comprising: receiving, from a source network node, a first message requesting a conditional handover (CHO) or a conditional Primary Secondary Cell (PSCell) change; initiating or starting a counter or a timer in response to receiving the first message; receiving a second message indicating a completion of a RRC reconfiguration; stopping the counter or timer in response to receiving the second message; determining, based on the counter or timer, whether a parameter indicating a time the user equipment stayed in a cell is to be updated; if the parameter is determined to be updated, updating a latest and/or current PCell and/or PSCell entry of the user equipment history information (UHI); and if the parameter is determined not be updated, discarding the counter or timer.

Example Embodiment E2. The method of Example Embodiment E1, further comprising determining that the parameter is to be updated when a sum of the time the user equipment stayed in the cell and the counter is different from the time the user equipment stayed in the cell parameter received from the source network node during the CHO preparation.

Example Embodiment E3. The method of any one of Example Embodiments E1 to E2, wherein the target network node comprises a gNodeB (gNB).

Example Embodiment E4. A source network node comprising processing circuitry configured to perform any of the methods of Example Embodiments E1 to E3.

Example Embodiment E5. A computer program comprising instructions which when executed on a computer perform any of the methods of Example Embodiments E1 to E4.

Example Embodiment E6. A computer program product comprising computer program, the computer program comprising instructions which when executed on a computer perform any of the methods of Example Embodiments E1 to E4.

Example Embodiment E7. A non-transitory computer readable medium storing instructions which when executed by a computer perform any of the methods of Example Embodiments E1 to E4.

### Group F Example Embodiments

Example Embodiment F1. A user equipment comprising: processing circuitry configured to perform any of the steps of any of the Group A Example Embodiments; and power supply circuitry configured to supply power to the processing circuitry.

Example Embodiment F2. A network node comprising: processing circuitry configured to perform any of the steps of any of the Group B, C, and E Example Embodiments; power supply circuitry configured to supply power to the processing circuitry.

Example Embodiment F3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment F4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to receive the user data from the host.

Example Embodiment F5. The host of the previous Example Embodiment, wherein the cellular network further includes a network node configured to communicate with the UE to transmit the user data to the UE from the host.

Example Embodiment F6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment F8. The method of the previous Example Embodiment, further comprising: at the host, executing a host application associated with a client application executing on the UE to receive the user data from the UE.

Example Embodiment F9. The method of the previous Example Embodiment, further comprising: at the host, transmitting input data to the client application executing on the UE, the input data being provided by executing the host application, wherein the user data is provided by the client application in response to the input data from the host application.

Example Emboidment F10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to transmit the user data to the host.

Example Emboidment F11. The host of the previous Example Embodiment, wherein the cellular network further includes a network node configured to communicate with the UE to transmit the user data from the UE to the host.

Example Embodiment F12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F13. A method implemented by a host configured to operate in a communication system that further includes a network node and a user equipment (UE), the method comprising: at the host, receiving user data transmitted to the host via the network node by the UE, wherein the UE performs any of the steps of any of the Group A Example Embodiments to transmit the user data to the host.

Example Embodiment F14. The method of the previous Example Embodiment, further comprising: at the host, executing a host application associated with a client application executing on the UE to receive the user data from the UE.

Example Embodiment F15. The method of the previous Example Embodiment, further comprising: at the host, transmitting input data to the client application executing on the UE, the input data being provided by executing the host application, wherein the user data is provided by the client application in response to the input data from the host application.

Example Embodiment F16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, C, and E Example Embodiments to transmit the user data from the host to the UE.

Example Embodiment F17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment F18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, C, and E Example Embodiments to transmit the user data from the host to the UE.

Example Embodiment F19. The method of the previous Example Embodiment, further comprising, at the network node, transmitting the user data provided by the host for the UE.

Example Emboidment F20. The method of any of the previous 2 Example Embodiments, wherein the user data is provided at the host by executing a host application that interacts with a client application executing on the UE, the client application being associated with the host application.

Example Embodiment F21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, C, and E Example Embodiments to transmit the user data from the host to the UE.

Example Embodiment F22. The communication system of the previous Example Embodiment, further comprising: the network node; and/or the user equipment.

Example Embodiment F23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, C, and E Example Embodiments to receive the user data from a user equipment (UE) for the host.

Example Embodiment F24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F25. The host of the any of the previous 2 Example Embodiments, wherein the initiating receipt of the user data comprises requesting the user data.

Example Embodiment F26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, and E Example Embodiments to receive the user data from the UE for the host.

Example Embodiment F27. The method of the previous Example Embodiment, further comprising at the network node, transmitting the received user data to the host.

1.-22. (canceled)

23. A method by a target network node associated with a Conditional Handover (CHO) or Conditional Primary Secondary Cell Group Cell (PSCell) change of a user equipment (UE), the method comprising:
receiving, from a source network node, a first message requesting the CHO or Conditional PSCell change of the UE, the first message comprising user equipment history information (UHI);
receiving, from the UE, a second message indicating a completion of applying a Radio Resource Control (RRC) reconfiguration; and
updating the UHI based on an amount of time between receiving the first message comprising the UHI and receiving the second message indicating the completion of applying the RRC reconfiguration.

24. The method of claim 23, wherein the UHI comprises a parameter indicating an amount of time that the UE stayed in a cell associated with the source network node before the source network node sent the first message to the target network node.

25. The method of claim 24, wherein the cell associated with the source network node comprises a Primary Cell (PCell) or a PSCell.

26. The method of claim 24, further comprising transmitting a third message to a candidate target network node during a handover of the UE from the target network node to the candidate target network node, the third message comprising:
the updated UHI associated with the source network node indicating an updated amount of time that the UE stayed in the cell associated with the source network node; and
UHI associated with the target network node indicating an amount of time that the UE stayed in a cell associated with the target network node.

27. The method of claim 23, wherein updating the UHI comprises updating a PCell entry or PSCell entry in the UHI, the PCell entry or the PSCell entry being associated with a cell of the source network node.

28. The method of claim 23, wherein the first message comprises a handover request message.

29. The method of claim 23, wherein the second message comprises a RRCReconfiguration message.

30. The method of claim 23, further comprising:
starting a timer in response to receiving the first message; and
stopping the timer in response to receiving the second message.

31. The method of claim 30, wherein updating the UHI based on the amount of time between receiving the first message and receiving the second message comprises updating the UHI based on an amount of time associated with the timer.

32. The method of claim 23, wherein the UHI comprises a plurality of parameters, each parameter associated with an amount of time the UE stayed in a respective one of a plurality of cells.

33. The method of claim 23, further comprising transmitting, to the source network node, information indicating a successful completion of the CHO or the conditional PSCell change from the source network node cto the target network node, the information indicating that the UE successfully accessed a target cell associated with the target network node.

34. A target network node associated with a Conditional Handover (CHO) or Conditional Primary Secondary Cell Group Cell (PSCell) change of a user equipment (UE), the target network node comprising processing circuitry configured to:
receive, from a source network node, a first message requesting the CHO or Conditional PSCell change of the UE, the first message comprising user equipment history information (UHI);
receive, from the UE, a second message indicating a completion of applying a Radio Resource Control (RRC) reconfiguration; and
update the UHI based on an amount of time between receiving the first message comprising the UHI and receiving the second message indicating the completion of the applying the RRC reconfiguration.

35. The target network node of claim 34, the UHI comprises a parameter indicating an amount of time that the UE stayed in a cell associated with the source network node before the source network node sent the first message to the target network node.

36. The target network node of claim 35, wherein the cell associated with the source network node comprises a Primary Cell (PCell) or a PSCell.

37. The target network node of claim 35, wherein the processing circuitry is configured to transmit a third message to a candidate target network node during a handover of the UE from the target network node to the candidate target network node, the third message comprising:
the updated UHI associated with the source network node indicating an updated amount of time that the UE stayed in the cell associated with the source network node; and
UHI associated with the target network node indicating an amount of time that the UE stayed in a cell associated with the target network node.

38. The target network node of claim 34, wherein, when updating the UHI, the processing circuitry is configured to update a PCell entry or PSCell entry in the UHI, the PCell entry or the PSCell entry being associated with a cell of the source network node.

39. The target network node of claim 34, wherein the first message comprises a handover request message.

40. The target network node of claim 34, wherein the second message comprises a RRCReconfiguration message.

41. The target network node of claim 34, wherein the processing circuitry is configured to:
start a timer in response to receiving the first message; and
stop the timer in response to receiving the second message.

42. The target network node of claim 41, wherein, when updating the UHI based on the amount of time between receiving the first message and receiving the second message, the processing circuitry is configured to update the UHI based on an amount of time associated with the timer.

43. The target network node of claim 34, wherein the UHI comprises a plurality of parameters, each parameter associated with an amount of time the UE stayed in a respective one of a plurality of cells.

44. The target network node of claim 34, wherein the processing circuitry is configured to transmit, to the source network node, information indicating a successful completion of the CHO or the conditional PSCell change from the source network node to the target network node, the information indicating that the UE successfully accessed a target cell associated with the target network node.
